(19) United States
(12) Patent Application Publication
(10) Pub. No.: US 2007/0289283 A1
(43) Pub. Date: Dec. 20, 2007

(54) RAKING DEVICES FOR PULL-TYPE AND PUSH-TYPE APPLICATIONS AND ADAPTERS AND METHODS FOR RETROFITTING PULL-TYPE RAKING DEVICES FOR PULL- AND PUSH-TYPE APPLICATIONS

(76) Inventor: Orest J. Hanas, Lehighton, PA (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/765,480

(22) Filed: Jun. 20, 2007

Related U.S. Application Data
(60) Provisional application No. 60/815,161, filed on Jun. 20, 2006.
(60) Provisional application No. 60/891,968, filed on Feb. 28, 2007.

(51) Int. Cl. A01D 7/00

(52) U.S. Cl. 56/400.14

(57) ABSTRACT

Raking devices are provided for switching between pull-type applications and push-type applications. The raking devices include a toothed blade having a pushing surface and a plurality of teeth with free ends. For pull-type applications, the raking device is arranged to place the free ends of the teeth in engagement with the ground. For push-type applications, the raking device is turned over to place the pushing surface in engagement with the ground. An undercarriage of the raking device may be provided with wheels or other transport members for enhanced maneuverability and control during push-type applications. Adapters and methods are also provided for retrofitting a pull-type rake for use in both pull- and push-type applications.

### CROSS REFERENCE TO RELATED APPLICATIONS

This application claims priority from and the benefit of provisional patent application Ser. No. 60/815,161, filed Jun. 20, 2006, and provisional patent application Ser. No. 60/891,968, filed Feb. 28, 2007, both of which are hereby incorporated herein by reference.

### BACKGROUND

1. Field of the Disclosure

This invention generally relates to tools for yard work, and more particularly, raking tools for moving and gathering lawn debris.

2. Description of Related Art

Proper care is necessary for maintaining a healthy and attractive lawn. From time to time debris, such as leaves, branches, and grass clippings, becomes dispersed in a yard and must be gathered and removed. One of the most common methods is to use a rake to gather debris into a pile for removal. A typical rake is a long-handled device with a head having a number of projecting teeth for engaging the ground and moving debris. The rake is gripped by the handle and pulled toward the user, or pulled at an angle to the user, to move debris. This works adequately for light yard work, involving a small amount of dry debris. However, when dealing with a larger amount of debris, in particular, a larger amount of wet debris, the task becomes unduly burdensome and time-consuming, or even impracticable.

Accordingly, there is a need for a device suitable for typical raking operations, as well as for more demanding operations involving deep and/or wet lawn debris.

As set forth in more detail below, the present disclosure sets forth an improved raking device embodying advantageous alternatives to prior art pull-type raking devices.

### SUMMARY

In general, the present disclosure is directed to raking devices for moving and gathering lawn debris. More particularly, the present disclosure sets forth a reversible pull-type and push-type lawn debris raking device. The raking device includes an elongated handle member with first and second ends. The proximal end of a bearing member is connected to the first end of the handle member. A toothed blade having a plurality of teeth disposed at a substantially perpendicular angle to the long axis of the handle member is connected to a distal end of the bearing member. The teeth have free ends which coact with lawn debris and the ground when the raking device is in a pull-type raking disposition. The toothed blade may also have a relatively stiff pushing surface disposed substantially perpendicular to the long axis of the handle member. The pushing surface coacts with lawn debris when the raking device is in a push-type raking disposition. The raking device also includes one or more ground-engaging transport members mounted on the bearing member, such that the transport members contact the ground in the push-type raking disposition.

Raking devices generally described above provide an effective push-type raking disposition in addition to the known pull-type raking disposition. The raking devices described herein are particularly well-suited for moving and gather lawn debris, especially deep and/or wet debris. Of course, it will be appreciated that the raking devices described herein are not limited to particular applications, but may be used for a number of yard work tasks, such as loosening or smoothing earth in gardens and farms and smoothing and leveling crushed stone, cement, or asphalt when building or repairing sidewalks, driveways, or roadways.

According to another aspect of the present disclosure, adapters are provided for retrofitting a rake for both push- and pull-type applications.

According to yet another aspect of the present disclosure, methods for retrofitting a rake for both push- and pull-type applications are provided.

### BRIEF DESCRIPTION OF THE DRAWINGS

FIG. 1 is a side perspective view of one embodiment of a raking device suitable for push-type applications;

FIG. 2 is a rear perspective view of the raking device of FIG. 1;

FIG. 3 is a side perspective view of another raking device suitable for push-type applications;

FIG. 4 is a rear perspective view of the raking device of FIG. 3;

FIG. 5 is an end view of the raking device of FIG. 3, showing a pushing surface in greater detail;

FIG. 6 is a perspective view a kit or adapter for retrofitting a rake for both pull- and push-type applications;

FIGS. 7 and 8 illustrate rakes retrofitted for both pull- and push-type applications; and

FIGS. 9-11 illustrate a method for retrofitting a rake for both pull- and push-type applications.

### DESCRIPTION OF THE ILLUSTRATED EMBODIMENTS

It will be understood that the disclosed embodiments generally described below and illustrated in the attached drawings are merely exemplary of the present invention, which may be embodied in various forms. Therefore, specific details disclosed herein are not to be interpreted as limiting, but rather as representative and provide a basis for variously employing the present invention in any appropriate manner understood by one of ordinary skill in the art.

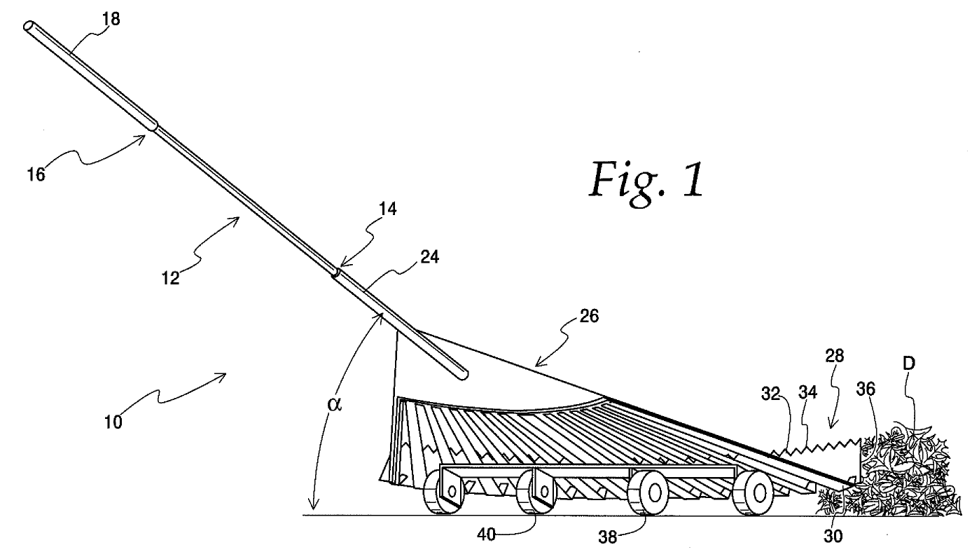

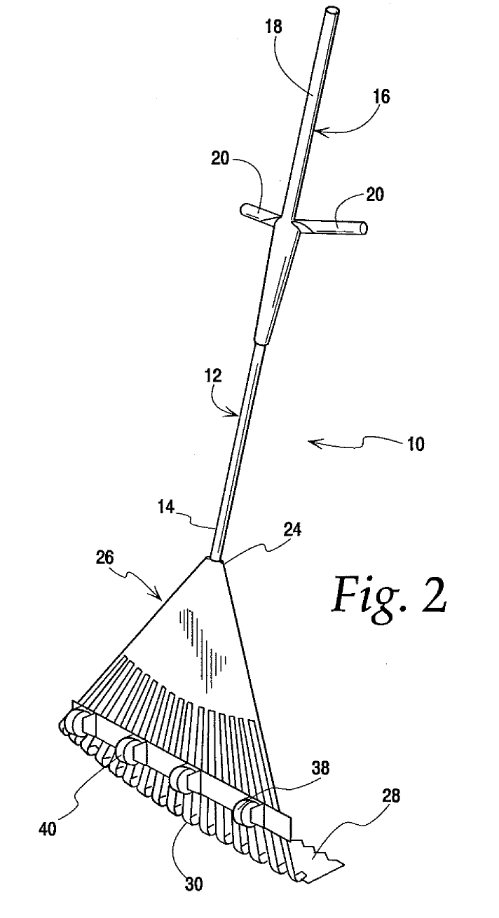

FIGS. 1 and 2 show a reversible raking device according to an aspect of the present invention. The raking device is generally identified as element 10 in FIGS. 1 and 2. The raking device 10 will typically include an elongated handle member 12 having a first end 14 and a second end 16. In the illustrated embodiment, the handle member 12 is a generally rod-shaped structure defining a long axis along its length. The handle member 12 may be comprised of any of a number of materials, such as wood, metal, or plastic. The handle member 12 is typically gripped at the second end 16 during both push-type and pull-type applications. In order to enhance comfort and grip, the second end 16 may be made of or at least partially encapsulated within a separate material, such as pliable foam rubber layer 18. The second end 16 may also be adapted to include ridges or the like for accommodating fingers of the user. In one embodiment, the handle member 12 may include one or more radially extending gripping members 20 associated with the second end 16, as shown in FIG. 2. The gripping members 20 provide additional support for push-type applications. It will be appreciated that the gripping members 20 may be provided in other configurations, such as angled or curved, without departing from the scope of the present disclosure.

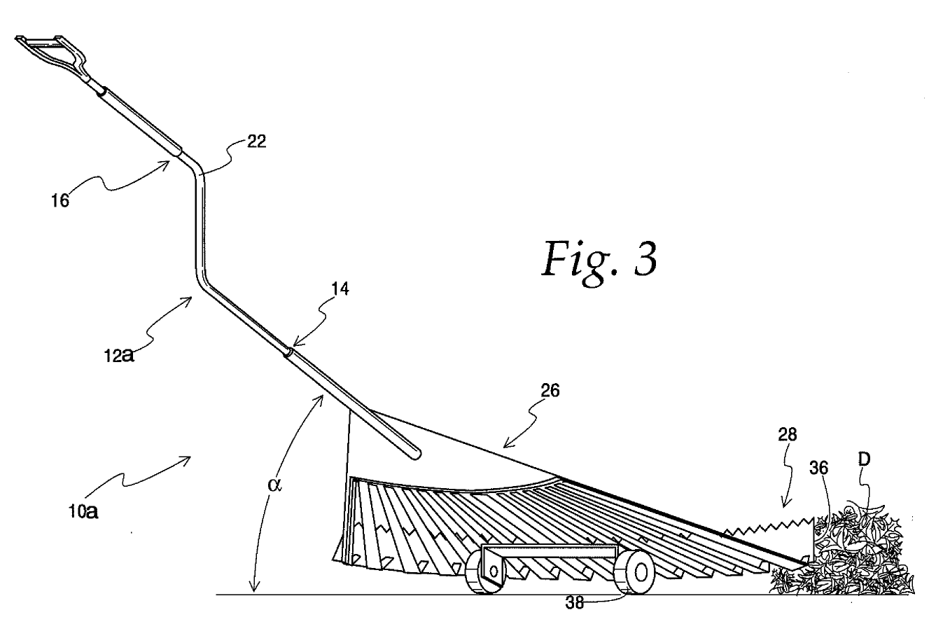

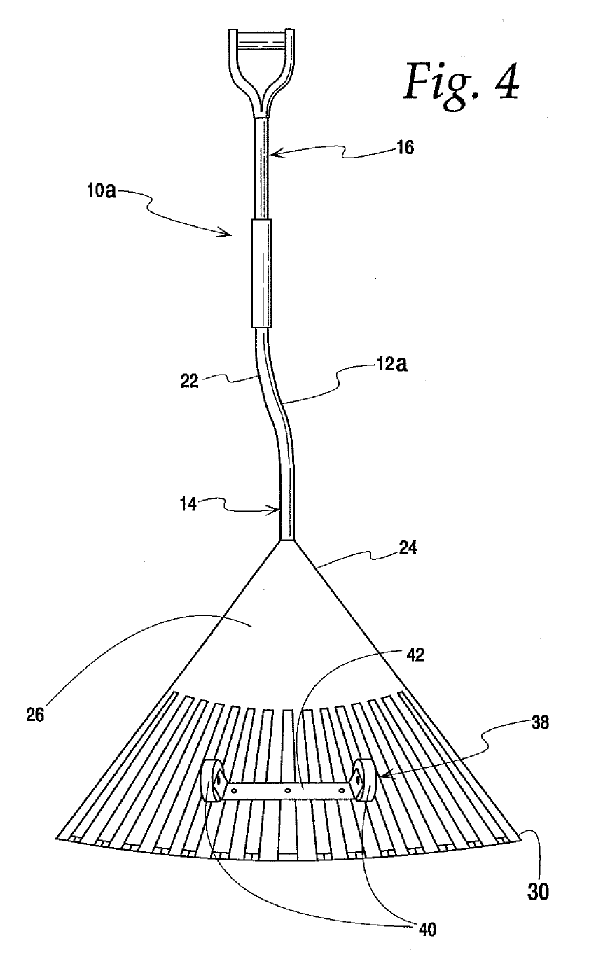

FIGS. 3 and 4 illustrate a raking device 10a having another handle member 12a according to the present disclosure. The first and second ends 14 and 16 are relatively parallel, but vertically offset by a curved intermediate portion 22. The handle member 12a of FIGS. 3 and 4 may be more comfortable for some users than the handle member 12 of FIGS. 1 and 2. Advantageously, the handle member 12a, and particularly the curved portion 22, may be detachable, collapsible, foldable, or rotatable to simplify shipping, warehousing, and home storage. The length of the handle member 12, 12a and, thus the overall length of the raking device 10, 10a may vary, but in one embodiment the raking device 10, 10a is approximately 65 inches long. Other than the shape of the handle member 12a, the raking device 10a of FIGS. 3 and 4 operates identically to the embodiment of FIGS. 1 and 2 and conforms to the following description.

The proximal end 24 of a bearing member or head 26 is connected to the first end 14 of the handle member 12, 12a. Typically, the bearing member 26 is generally triangular and planar with opposing front and rear faces. A toothed blade 28 is either integral with or connected to a distal end 30 of the bearing member 26. The toothed blade 28 is defined by a plurality of teeth 32 disposed at a substantially perpendicular angle to the long axis of the handle member 12, 12a and to the faces of the bearing member 26. The toothed blade 28 may be provided as a single structure or in several parts, each defining one or more teeth 32. Each tooth 32 has a free end 34, pointed generally upwardly in the push-type disposition of FIGS. 1 and 3. For pull-type applications, the raking device 10, 10a is turned over, such that the free ends 34 face downwardly for coacting with lawn debris and the ground. Thus, it will be appreciated that raking devices according to the present invention may be used for typical pull-type applications.

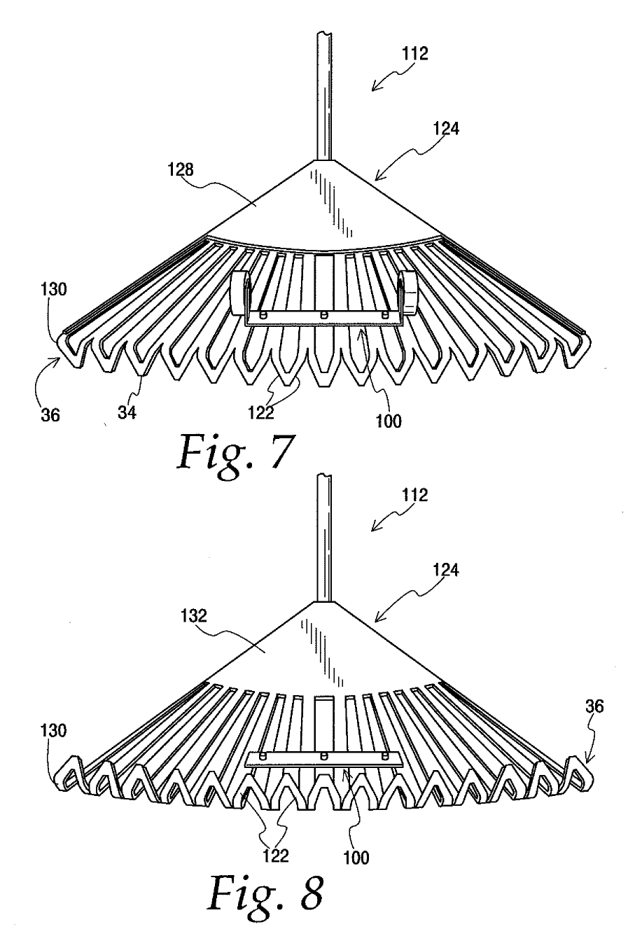

The portion of the teeth between the bearing member 26 and the free ends 34 defines a pushing surface 36, illustrated in FIGS. 1, 3, 5, 7, and 8. The pushing surface 36 is preferably relatively stiff compared to the somewhat flimsy, single-tine teeth of prior art pull-type rakes, in order to promote quick and efficient moving and gathering of deep and/or wet lawn debris in push-type applications. For example, in one embodiment each tooth 32 may be comprised of a two or more adjacent tines joined together at the free end 34 of the tooth 32 to define an apex of a triangle, as shown in FIGS. 7 and 8. Teeth of this type are generally sturdier than single-tine teeth of certain prior art rakes.

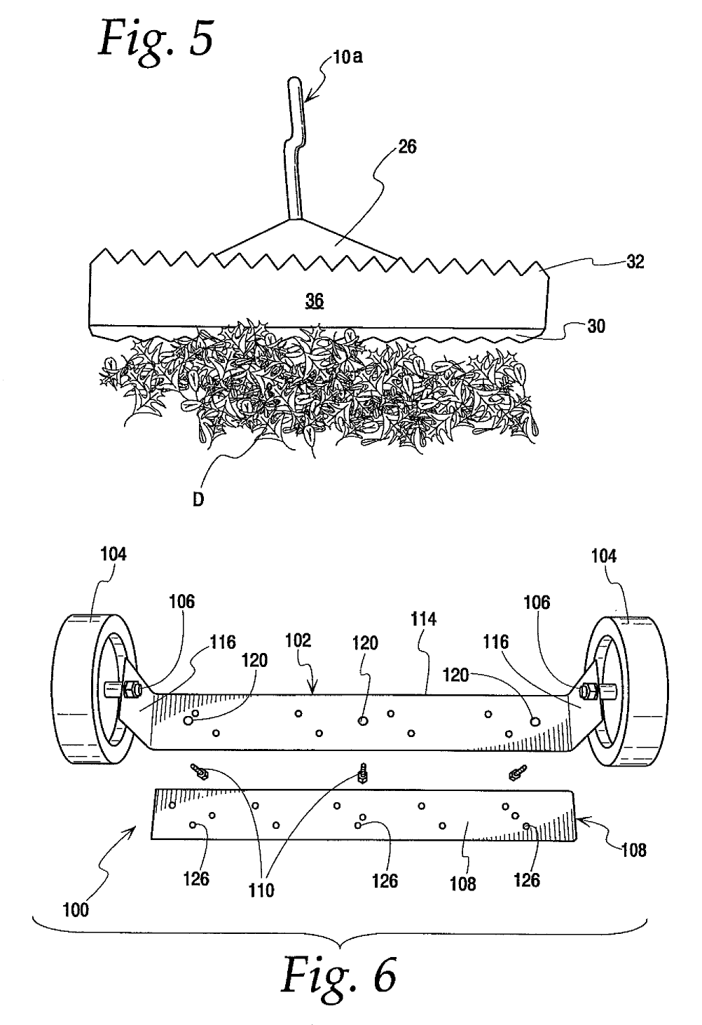

In another embodiment, illustrated generally in FIG. 5, the pushing surface 36 may comprise a single solid surface, such as a sturdy plastic panel that spans the width of the bearing member 26 for providing a sufficiently stiff pushing surface. The teeth 32 and/or the pushing surface 36 may be comprised of other materials, such as metal or wood with departing from the scope of the present disclosure. In a specific embodiment, illustrated generally in FIG. 5, the pushing surface 36 is a solid plastic panel approximately 32 inches wide and approximately 6 inches deep. The illustrated embodiment includes 16 teeth 32, each being approximately 2 inches deep.

The opposite face or undercarriage of the bearing member 26 may include at least one transport member 38 that is adapted to engage the ground in the push-type disposition of FIGS. 1 and 3. The transport member 38 allows the bearing member 26 to move along the ground in the push-type disposition without dragging or becoming snagged. In one embodiment, best illustrated in FIGS. 2 and 4, a plurality of wheels 40 are spaced along the width of the bearing member 26. This may be advantageous in order to ensure that the raking device 10, 10a moves along the ground without tilting to the side, which may allow debris to pass below the pushing surface 36. While smooth wheels 40 are illustrated, other transport members are possible, such as toothed or spiked wheels for ground aeration or rollers, or one or more members having a smoothed, curved surface adapted for sliding over the ground.

The transport members 38 may be placed at other locations of the raking device or mounted to other structures without departing from the scope of the present disclosure. For example, the transport members 38 may be mounted to the first end 14 of the handle member 12, 12a with elongated legs (not illustrated) in order to engage the ground a greater distance behind the pushing surface 36 and create a stand or tripod to support the raking device 10, 10a. Alternatively, the transport members 38 may be arranged to contact the ground in front of the pushing surface 36, but this may not be preferred because it can disrupt the pull-type functionality of the device and because the transport members 38 may become clogged with lawn debris. Alternatively, the device may have transport members mounted at two or more locations of the device.

For push-type applications, as illustrated in FIGS. 1 and 3, the raking device 10, 10a is gripped and oriented to place the transport members 38 in engagement with the ground. The raking device 10, 10a is then pushed against debris D, which is contacted and moved by the pushing surface 36. It will be appreciated that the raking device 10, 10a is readily reversible between pull-type applications and push-type applications by turning the bearing member 26 over. However, it should be noted that the term “push-type applications” is not limited to applications requiring the user to push the raking device, but instead broadly refers to uses wherein the raking device is moved in a direction away from the user to contact and move debris. For example, the raking device may be motorized or otherwise include a power source to drive it in a direction away from the user for contacting and moving debris.

For best results in push-type applications, the bottom of the pushing surface 36 contacts the ground to prevent debris from passing beneath the pushing surface 36. In order to encourage proper usage of the raking device 10, 10a, the transport members 38 may be placed a selected distance from the pushing surface 36, so as to create a “comfort angle” at which the handle member 12, 12a is held to place the pushing surface 36 in contact with the ground. The “comfort angle” is generally designated herein as α. For example, in one embodiment illustrated in FIGS. 1-4, a plurality of wheels 40 having a diameter of 3 inches are mounted to the bearing member 26 by suitable mounting means, illustratively two L-brackets, two flat brackets, and a number of mechanical fasteners. The wheels 40 are mounted such that the “comfort angle” α is approximately 45 degrees, with the wheels 40 engaging the ground approximately 3.5 inches behind the pushing surface 36 and supporting the associated portion of the bearing member 26 approximately 3.5 inches above the ground. The optimal “comfort angle” will vary by user, so the raking devices may be provided with an assortment of “comfort angles.” Alternatively, the “comfort angle” may be customized for individual users, whereby the position of the transport members 38 may be adjustable relative to the pushing surface 36 and/or to the bearing member 26.

In one embodiment, illustrated generally in FIG. 4, a pair of wheels 40 each have a diameter of approximately 3 inches. The wheels 40 are illustratively mounted to the undercarriage of the bearing member 26 approximately 4 inches from the pushing surface 36, approximately 13 inches apart from each other, and on 2-inch high brackets 42.

According to another aspect of the present disclosure, a rake, such as, but not limited to a typical pull-type rake may be adapted for pull-type and push-type applications with a kit. In one embodiment, the kit includes a toothed blade and transport members according to the foregoing description, as well as suitable mounting means. In order to adapt a prior art pull-type rake, the toothed blade is mounted to the existing teeth, with the free ends and pushing surface extending in the same general direction as the existing teeth, and the transport members are mounted to the opposite face of the existing bearing member.

A kit or adapter 100 is illustrated in FIG. 6, with FIGS. 7 and 8 showing typical pull-type rakes retrofitted for both push- and pull-type applications. The adapter 100 includes a C bracket 102, two wheels 104, two axles 106, an opposing bracket 108, and a plurality of connectors 110. Of course, the number of wheels, brackets, and connectors may vary depending on need and rake size. For example, 3-4 wheels across two brackets with ends that are at least substantially adjacent to each other may be provided.

In one embodiment, the C bracket 102 is comprised of an approximately 1.25 inch wide galvanized 22-gauge flexible steel. When a retrofitted rake 112 (FIGS. 7 and 8) is rolled over uneven terrain, the rolling motion of the wheels 104 may create vibrations that could potentially damage the tines of a pull-type rake to which the adapter 100 is attached. The flexible steel absorbs these vibrations, thereby extending the life of the retrofitted rake 112. The illustrated C bracket 102 is a unitary steel strip with an approximately 9 inch long mid-section 114, with a 90 degree bend section 116 on each end thereof. Each bend section 116 may be approximately 2.25 inches long.

In one embodiment, one 3-inch diameter plastic wheel 104 is mounted on each bend section 116 approximately 2 inches from the intersection of the mid-section 114 and the bend section 116. Of course, the adapter 100 may be provided with larger wheels for larger rakes or lawns with longer grass, in which case the bend sections 116 are longer and the wheels are mounted a greater distance away from the intersection of the mid-section 114 and the bend section 116. Regardless of the size of the wheels, the location of the wheel mountings is selected to allow for unobstructed rolling of the wheels over uneven lawn terrain.

Each wheel 104 is mounted on an axle 106, which passes through a hole in the bend section 116 (not illustrated). For 3-inch diameter wheels, the axles 106 are approximately 1.38 inch long shoulder screws (each with a 1.0 inch long, 0.25 inch diameter shoulder) and are coaxial to each other and substantially parallel to the bracket mid-section 114. The shoulder screws are used in order to prevent over-tightening during the assembly process and thus ensure the free motion of the wheels 104 on the axles 106.

The mid-section 114 of the C bracket 102 contains three mounting holes 120. The central mounting hole is located in the center of the mid-section 114, equidistant from the ends thereof, and the other two mounting holes are located 3.75 inches away from the center hole. The locations of the mounting holes 120 facilitate the mounting of the adapter 100 between the rake tines 122 without the need to drill any holes in the bearing member 124 of the rake. The five mounting holes (two in the bend sections 116 and three in the mid-section 114) in the C bracket 102 are 0.19 inch in diameter (#10 machine screw size).

In one embodiment, the opposing bracket 108 is 10.5 inches long and comprises a galvanized 1.25 inch wide, 22 gauge flexible steel strip. The opposing bracket 108 includes three #10 mounting holes 126, located to match the holes 120 in the C bracket 102.

In one embodiment, three #8×1.25 inches long machine screws 110 are used to mount the C bracket 102 and the opposing bracket 108 together and onto the tines 122, as described below. Self locking nuts are used throughout in order to ensure that no loosening of fasteners will occur during the rake's usage. It should be noted that the hole diameter is larger than the screw diameter to provide a loose and easy fit when the retrofitted rake 112 is assembled. In another embodiment, the holes 120 and 126 may be replaced by one or more slots. For example, each hole may instead be a slot approximately 0.19 inch wide and approximately 0.5 inch long to achieve easy assembly of the adapter 100.

The adapter 100 is intended to be mounted by the user on a standard pull-type leaf rake by placing the wheeled C bracket 102 on the back face 128 of the rake bearing member 124, located about 4 inches from the distal end 130 thereof, as shown in FIGS. 7 and 8. The opposing bracket 108 is placed on the front face 132 of the bearing member 124 with the mounting holes 126 aligned with those of the C bracket 102 to pass between adjacent tines 122. With the holes properly aligned, screws 110 or other connectors are used to connect the brackets and secure them to the rake. Hence, no drilling of holes or other physical modification to the rake is required.

According to another method of retrofitting a standard pull-type leaf rake, an adapter 100 as generally illustrated in FIG. 6 is provided, along with a pull-type leaf rake. The opposing bracket 108 is placed on a support surface 134 with screws 110 extending through the mounting holes 126 away from the support surface 134 (FIG. 9). The support surface 134 is typically a substantially horizontal surface, such as a tabletop, with an edge 136. Advantageously, the opposing bracket 108 is oriented substantially parallel to the edge 136 and positioned a distance X therefrom. The distance X may vary, but is approximately 2 inches in one embodiment.

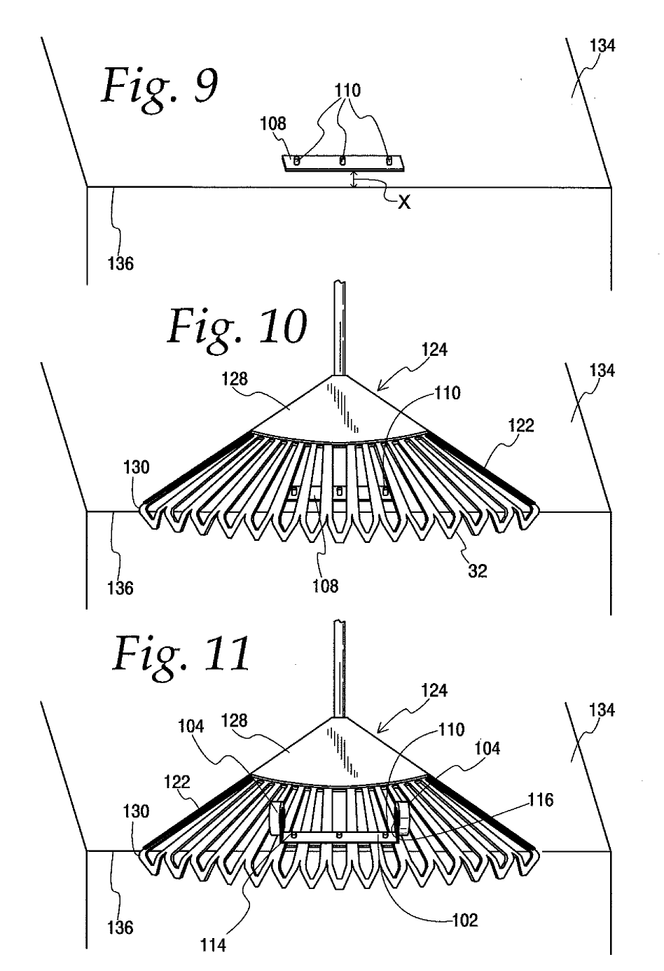

The bearing member 124 of the rake is placed onto the support surface 134, with the front face 132 facing the support surface 134 and at least partially overlaying the opposing bracket 108 (FIG. 10). The rake is positioned such that the distal end 130 of the tines 122 overhangs the edge 136 and abuts against a portion of the edge 136 which is generally perpendicular to the support surface, the opposing bracket 108 is laterally centered with respect to the tines 122, and each screw 110 extends between adjacent rake tines 122 to the back face 128 of the bearing member 124. So positioning the rake ensures that adapter 100 will be properly positioned to provide a comfort angle, such as 450, when it is secured to the bearing member 124.

With the rake positioned against the support surface 134, the mid-section 114 of the C bracket 102 is placed against the back face 128 of the bearing member 124, with bend sections 116 extending away from the bearing member 124 and the screws 110 passing through the C bracket mounting holes 120 (FIG. 11). Typically, the C bracket 102 is provided with the wheels 104 already attached to the bend sections 116 to shorten the assembly process.

The C bracket 102 is then secured to the bearing member 124 by applying a locknut to the portion of each screw 110 extending beyond the mid-section 110. This may be done by hand and/or by holding the head of the locknut stationary, typically with pliers, and tightening the screw with a screwdriver. If the rake is to be suited with a toothed blade 28, it may be attached either before or after the adapter 100 is attached.

In a push-type application, the retrofitted rake 112 is positioned with the wheels 104 engaging the ground. The operator uses the pushing surface 36 of the rake 112 to push the leaves away by applying his or her bodyweight in a push motion, thus requiring little physical effort for clearing the area of the heavy, deep wet or dry leaves.

It will be understood that the embodiments described above are illustrative of some of the applications of the principles of the present invention. Numerous modifications may be made by those skilled in the art without departing from the spirit and scope of the invention, including those combinations of features that are individually disclosed or claimed herein. For example, the toothed blade of FIGS. 1-4 may be integrally formed with the bearing member, similar to the tines of a typical pull-type rake, and the adapter of FIGS. 6-11 may be provided with a separate toothed blade attachment, according to the general description of the embodiments of FIGS. 1-4. Further, raking devices according to the present disclosure may be comprised of any of a number of materials or combinations of materials, including but not limited to wood, plastic, aluminum, and steel. For these reasons, the scope of the invention is not limited to the above description but is as set forth in the following claims.

1. A reversible pull-type and push-type lawn debris raking device comprising:
an elongated handle member having first and second ends for pushing and pulling the device;
a bearing member having a proximal end and a distal end, said proximal end connected to the first end of the handle member;
a toothed blade connected to the distal end of the bearing member and comprising a plurality of teeth disposed at a substantially perpendicular angle to a long axis of the handle member, whereby free ends of the teeth coact with lawn debris and the ground when the raking device is in a pull-type raking disposition;
a pushing surface disposed substantially perpendicular to the long axis of the handle member, whereby the pushing surface coacts with lawn debris when the raking device is in a push-type raking disposition; and
one or more ground-engaging transport members mounted on the bearing member, whereby said transport members contact the ground when the raking device is in the push-type raking disposition.

2. The raking device of claim 1, wherein said first end and said second end of the handle member are generally parallel and offset from each other by a curved intermediate portion of the handle member.

3. The raking device of claim 1, wherein a portion of the pushing surface is adapted to contact the ground in the push-type raking disposition and the handle member extends approximately 45° from the ground when the pushing surface and the transport member contact the ground in the push-type raking disposition.

4. The raking device of claim 1, wherein the position of the transport member is adjustable to vary the distance between the transport member and the pushing surface.

5. The raking device of claim 1, wherein said pushing surface is defined by cooperating surfaces of said teeth.

6. The raking device of claim 1, wherein said pushing surface comprises a panel connected to said teeth.

7. The raking device of claim 6, wherein said panel is more rigid than said teeth.

8. An adapter for retrofitting a pull-type raking device having a handle member with first and second ends; a bearing member having a proximal end, a distal end, a front face, and a back face, said proximal end connected to the first end of the handle member; and a plurality of tines at the distal end of the bearing member and extending away from the bearing member for coacting with lawn debris and the ground when the front face of the bearing member is facing the ground in a pull-type raking disposition, the adapter comprising:
a first bracket securable to the front face of the bearing member;
a second bracket securable to the first bracket and the back face of the bearing member; and
one or more ground-engaging transport members mounted on the second bracket, whereby the transport member is adapted to contact the ground when the back face of the bearing member is facing the ground in a push-type raking disposition.

9. The adapter of claim 8, wherein the second bracket is securable to the first bracket by one or more fasteners and the first and second brackets include one or more mounting openings each adapted for receiving a portion of at least one fastener.

10. The adapter of claim 9, wherein each of said mounting openings is configured such that the associated fastener passes between adjacent tines of the raking device.

11. The adapter of claim 8, wherein at least one of said brackets is generally flexible for absorbing vibrations during a push-type application.

12. The adapter of claim 8, wherein said second bracket is generally C-shaped, with a mid-section securable to the back face of the raking device and a pair of bend sections extending away from the back face of the raking device, and wherein each bend section includes an associated transport member.

13. A method of retrofitting a pull-type raking device for pull- and push-type applications, comprising:
providing a pull-type raking device having a handle member with first and second ends; a bearing member having a proximal end, a distal end, a front face, and a back face, said proximal end connected to the first end of the handle member; and a plurality of tines at the distal end of the bearing member and extending away from the bearing member for coacting with lawn debris and the ground when the front face of the bearing member is facing the ground in a pull-type raking disposition;
providing a first bracket;
providing a second bracket having one or more ground-engaging transport members;
positioning the first bracket against the front face of the raking device bearing member;
positioning the second bracket against the back face of the raking device bearing member; and
securing the first bracket to the second bracket.

14. The method of claim 13, wherein said securing the first bracket to the second bracket includes passing one or more fasteners between adjacent tines of the raking device, from a mounting opening of one bracket to a mounting opening of the other bracket.

15. The method of claim 14, wherein said positioning the first bracket against the front face of the raking device bearing member includes:
placing the first bracket on a support surface with at least one fastener received in the mounting opening of the first bracket and extending away from the support surface; and
placing the bearing member of the raking device over the first bracket with the front face of the bearing member facing the support surface, such that the fastener passes between adjacent tines of the raking device.

16. The method of claim 15, wherein said placing the bearing member of the raking device over the first bracket includes positioning a distal end of the tines of the raking device to overhang an edge of the support surface.

17. The method of claim 16, wherein said placing the bearing member of the raking device over the first bracket includes positioning the distal end of the tines of the raking device to abut a portion of the edge which is generally perpendicular to the support surface.

18. The method of claim 17, wherein said positioning the first bracket against the front face of the raking device bearing member includes positioning the first bracket substantially parallel to the edge of the support surface.

19. The method of claim 18, wherein said positioning the first bracket against the front face of the raking device bearing member includes positioning the first bracket a selected distance from the edge of the support surface, such that the handle member extends at approximately 45° from the ground when the distal end of the tines and the transport member contact the ground in a push-type raking application.
